(19) United States
(12) Patent Application Publication
(10) Pub. No.: US 2021/0078582 A1
(43) Pub. Date: Mar. 18, 2021

(54) CONTROL SYSTEM FOR VEHICLE

(71) Applicant: Toyota Jidosha Kabushiki Kaisha, Toyota-shi Aichi-ken (JP)

(72) Inventor: Junichi Murase, Susono-shi (JP)

(21) Appl. No.: 17/017,046

(22) Filed: Sep. 10, 2020

(30) Foreign Application Priority Data
Sep. 12, 2019 (JP) 2019-166401

(51) Int. Cl. B60W 30/18; B60W 40/068; B60W 10/08

(52) U.S. Cl. CPC B60W 30/18172; B60W 2552/40; B60W 10/08; B60W 40/068

(57) ABSTRACT

A control system for a vehicle control system that stabilizes behavior of the vehicle during propulsion on a slippery road, by preventing an abrupt change in drive torque and an occurrence of hunting of a motor. When a coefficient of friction of a road surface is equal to or lower than a threshold value, a controller calculates a target motor speed that can adjust a slip ratio of a wheel to a target slip ratio, and executes a first feedback control to motor control torque thereby adjusting a motor speed to a target speed.

### CROSS REFERENCE TO RELATED APPLICATIONS

The present application claims the benefit of priority to Japanese Patent Application No. 2019-166401 filed on Sep. 12, 2019 with the Japanese Patent Office, the disclosures of which are incorporated herein by reference in its entirety.

### BACKGROUND

### Field of the Disclosure

Embodiments of the present disclosure relate to the art of a control system for a vehicle in which a prime mover includes at least a motor, and specifically, to a control system configured to control a torque of a motor.

### Discussion of the Related Art

JP-A-2006-136176 describes a motor traction controller for preventing wheel slip of a vehicle. The motor traction controller taught by JP-A-2006-136176 is configured to execute a torque down control of the motor to increase traction force when wheel slip is detected. According to the teachings of JP-A-2006-136176, the motor torque is also controlled in such a manner as to protect electric circuits and mechanical parts. In addition, when switching the motor torque control from the torque down control to the protection control, the motor torque is controlled based on a magnitude of the motor torque. Thus, according to the teachings of JP-A-2006-136176, the torque down control and the protection control are executed cooperatively.

According to the teachings of JP-A-2006-136176, specifically, an occurrence of wheel slip is detected based on a wheel speed, and the motor is controlled in such a manner as to achieve a target torque upon detection of wheel slip. However, a coefficient of friction of a road surface changes continuously during propulsion of the vehicle. If the motor torque is controlled based on the wheel speed as taught by JP-A-2006-136176, a wheel slip ratio may not be reduced within a target range due to control delay or control error when travelling on a snow-covered road or an ice-covered road. That is, the control to reduce the motor torque and the control to increase the motor torque will be executed alternately when the wheel slips and when the slipping wheel grips the road surface again. Consequently, the motor torque may fluctuate with respect to a target a target torque or a slip ratio of the wheel may fluctuate with respect to a target slip ratio due to hunting of the motor, and the behavior of the vehicle may be disturbed.

In addition, when the vehicle enters a zone in which a friction coefficient of the road surface is high during occurrence of the hunting of the motor, the traction control is terminated and the motor torque is controlled based on a position of an accelerator pedal, and as a result, the motor torque may be changed abruptly. Specifically, the motor thus adopted as a prime mover of vehicles is controlled electrically to enhance response, therefore, when the friction coefficient of the road surface is increased, the motor torque may be increased abruptly. Consequently, the vehicle may be accelerated more than expected.

### SUMMARY

Aspects of the present disclosure have been conceived noting the foregoing technical problems, and it is therefore an object of the present disclosure to provide a control system for a vehicle configured to stabilize the behavior of the vehicle during propulsion on a slippery road, by preventing an abrupt change in drive torque and an occurrence of hunting of a motor.

The control system according to the embodiment of the present disclosure is applied to a vehicle having a motor. The control system controls a torque of the motor based on a position of an accelerator pedal operated by a driver when a coefficient of friction of a road surface is equal to or higher than a threshold value. In order to achieve the above-explained objective, according to the exemplary embodiment of the present disclosure, a controller is configured to: determine whether the coefficient of friction of the road surface is equal to or lower than another threshold value; calculate a target speed of the motor that can adjust a slip ratio of a drive wheel to a target slip ratio when the coefficient of friction of the road surface is equal to or lower than the another threshold value; and execute a first feedback control to control the torque of the motor thereby adjusting a speed of the motor to the target speed.

In a non-limiting embodiment, the first feedback control may be executed based on a rotational angle of the motor detected by a resolver.

In a non-limiting embodiment, the controller may be further configured to: determine whether the coefficient of friction of the road surface increases equal to or higher than the threshold value; calculate an upper limit torque of the motor based on the coefficient of friction of the road surface and a required torque calculated based on the position of the accelerator pedal, when the coefficient of friction of the road surface increases equal to or higher than the threshold value; and execute a second feedback control to control the torque of the motor while employing the upper limit torque as a target torque.

In a non-limiting embodiment, the upper limit torque may be set lower than the required torque.

In a non-limiting embodiment, the controller may be further configured to apply a smoothing process to the torque of the motor thereby increasing the torque of the motor gradually to the upper limit torque, when the coefficient of friction of the road surface increases equal to or higher than the threshold value.

In a non-limiting embodiment, the controller may be further configured to continue the second feedback control for a predetermined period of time after the coefficient of friction of the road surface increases equal to or higher than the threshold value.

In a non-limiting embodiment, the controller may be further configured to: terminate the second feedback control after lapse of the predetermined period of time; and control the torque of the motor based on the position of the accelerator pedal after the termination of the second feedback control.

In a non-limiting embodiment, the target speed of the motor may include at least one of a speed at which the target slip ratio can be achieved, and a speed at which a target wheel speed can be achieved.

Thus, according to the exemplary embodiment of the present disclosure, the controller calculates the target speed of the motor that can adjust the slip ratio of the drive wheel to the target slip ratio when the coefficient of friction of the road surface is low and executes the first feedback control to control the torque of the motor thereby adjusting the speed of the motor to the target speed. According to the exemplary embodiment of the present disclosure, therefore, a control delay can be reduced compared to the conventional traction control in which a determination of wheel slip is made based on a wheel speed. For this reason, an occurrence of motor hunting can be prevented so that the torque of the motor is adjusted certainly to the target value. In addition, behavior of the vehicle can be stabilized during propulsion on a low friction road.

Further, in order to prevent an abrupt rise in the motor torque when the vehicle starts travelling on a high friction road, the controller calculates the upper limit torque of the motor based on the coefficient of friction of the road surface, and the required torque calculated based on the position of the accelerator pedal. Specifically, the upper limit torque is set lower than the required torque, and the torque of the motor is controlled based on the upper limit torque. That is, the torque of the motor is controlled by the feedback method based on the upper limit torque. According to the exemplary embodiment of the present disclosure, therefore, the torque of the motor is not increased to the required torque but to the upper limit torque. For this reason, the torque of the motor will not be increased abruptly when the vehicle starts travelling on the high friction road, and hence the behavior of the vehicle can be stabilized.

Furthermore, the controller applied the smoothing process to the torque of the motor during execution of the feedback control based on the upper limit value. According to the exemplary embodiment of the present disclosure, therefore, the torque of the motor is increased gradually toward the upper limit value. Since the upper limit torque is set slightly lower than the required torque, the driver will not be frustrated by the shortfall in the torque with respect to the required torque.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of a vehicle to which the control system according to the exemplary embodiment of the present disclosure is applied;

FIG. 2 is a flowchart showing one example of a routine executed by the control system according to the exemplary embodiment of the present disclosure;

FIG. 3 is a block diagram illustrating a feedback control of the motor executed by the control system according to the exemplary embodiment of the present disclosure;

FIG. 4 is a graph indicating an upper limit torque and a torque smoothing process; and

FIG. 5 is a graph indicating change in the motor torque during execution of the routine shown in FIG. 2.

### DETAILED DESCRIPTION OF EMBODIMENTS

Embodiments of the present disclosure will now be explained with reference to the accompanying drawings.

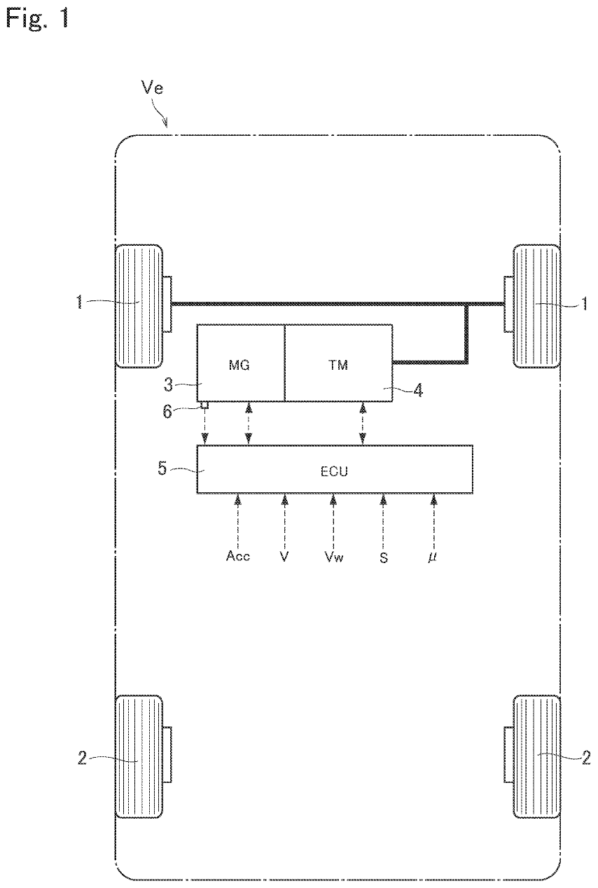

Referring now to FIG. 1, there is schematically shown one example of a structure of a vehicle Ve to which the control system according to the exemplary embodiment of the present disclosure is applied. The control system according to the exemplary embodiment of the present disclosure may be applied to an electric vehicle in which a prime mover comprises at least one motor, and a hybrid vehicle in which an engine is connected to a motor through a planetary gear set serving as a power split mechanism. That is, the control system according to the exemplary embodiment of the present disclosure is applied to a vehicle powered by the motor or propelled in an electric vehicle mode.

The vehicle Ve shown in FIG. 1 is a front-wheel-drive layout vehicle comprising a pair of front wheels 1 and a pair of rear wheels 2. In the vehicle Ve, a motor (referred to as “MG” in FIG. 1) 3 is adopted as a prime mover, and a power generated by the motor 3 is delivered to the front wheels 1 through a transmission (referred to as “TM” in FIG. 1) 4 and driveshafts (not shown) to propel the vehicle Ve. Here, it is to be noted that the control system may also be applied to a rear-wheel-drive layout vehicle in which power of the prime mover is delivered to the rear wheels 2, and to a four-wheel-drive vehicle in which power of the prime mover is delivered to both front wheels 1 and rear wheels 2.

For example, a permanent magnet type synchronous motor, and an induction motor may also be adopted as the second motor 3. That is, the motor 3 is a motor-generator that serves not only as a motor to generate torque when driven by electricity supplied thereto, but also as a generator to generate electricity when driven by torque applied thereto from an external source. The motor 3 is connected to a battery (not shown) so that speed and torque of the motor 3 are controlled electrically. When the vehicle Ve is decelerated, the motor 3 serves as a generator to translate a kinetic energy of the vehicle Ve into an electric energy, and electricity generated by the motor 3 is accumulated in the battery.

As to the transmission 4, for example, a conventional geared automatic transmission, a belt-driven continuously variable transmission, a toroidal continuously variable transmission etc. may be adopted as the transmission 4. Given that the vehicle Ve is a hybrid vehicle, the transmission 4 serves as a power distribution device for distributing and synthesizing powers of the engine and the motor(s).

In order to control the motor 3, the transmission 4 and so on, the vehicle Ve is provided with a controller 5 as an electronic control unit. The controller 5 comprises a microcomputer as its main constituent to which detection data and calculation data are transmitted from sensors and other equipment. For example, the controller 5 receives data about; a position Acc of an accelerator pedal (not shown); a wheel speed Vw of each of the front wheels 1 and rear wheels 2; a vehicle speed V; a coefficient of friction μ; a slip ratio S of each of the front wheels 1 and rear wheels 2; a speed Nm of the motor 3 detected by a resolver 6; a torque Tm of the motor 3; a state of charge of the battery, and so on. The controller 5 performs calculation based e.g., on the above-mentioned incident data and data as well as formulas installed in advance, and calculation results are transmitted in the form of command signal to e,g., the motor 3 and the transmission 4. Although only one controller 5 is depicted in the drawings, a plurality of controllers may be arranged in the vehicle Ve to control the specific devices individually.

The motor 3 generates torque in accordance with a position Acc of the accelerator pedal depressed by a driver corresponding to an operating amount of the accelerator. However, if the motor 3 is controlled based only on the position Acc of the accelerator pedal, the drive wheels may slip when travelling on a slippery road where a coefficient of friction μ is low. After that, when the vehicle Ve enters a zone in which the coefficient of friction μ of a road surface is high, a drive torque may be changed abruptly. In any of those cases, behavior of the vehicle Ve may become unstable. Therefore, the control system according to the exemplary embodiment of the present disclosure is configured to stabilize the behavior of the vehicle Ve during propulsion on the slippery road, and when the vehicle Ve enters the zone in which the coefficient of friction μ of a road surface is high.

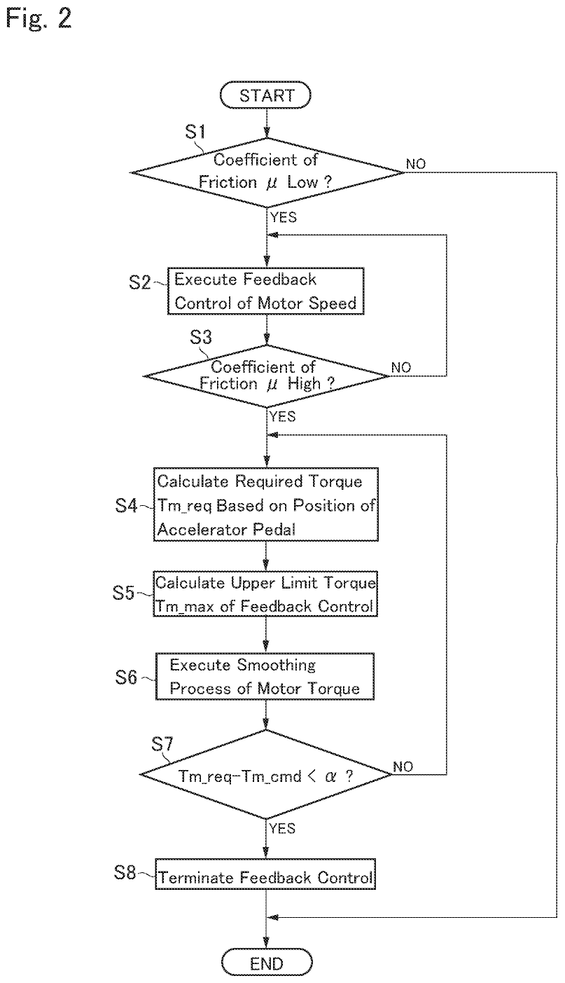

Specifically, according to the exemplary embodiment of the present disclosure, the control system executes the routine shown in FIG. 2 to control the torque Tm of the motor 3 during propulsion of the vehicle Ve.

At step S1, it is determined whether the coefficient of friction μ of the road surface is low. In other words, it is determined at step S1 whether at least one of the drive wheels (i.e., the front wheels 1) is/are slipping or expected to slip. For example, the coefficient of friction μ of the road surface may be estimated based on the torque Tm of the motor 3 and the wheel speed Vw of e.g., each of the front wheels 1, and the coefficient of friction μ of the road surface thus estimated is compared to a first threshold value μ1 as “another threshold value” of the exemplary embodiment of the present disclosure. Usually, wheel slip occurs if the coefficient of friction of the road surface is within a range from 0.1 to 0.4. According to the exemplary embodiment of the present disclosure, therefore, the first threshold value μ1 of the coefficient of friction μ of the road surface may be set within a range from 0.1 to 0.4. If the coefficient of friction μ of the road surface is greater than the first threshold value μ1 so that the answer of step S1 is NO, the routine returns without carrying out any specific control.

By contrast, if the coefficient of friction μ of the road surface is equal to or less than the first threshold value μ1 so that the answer of step S1 is YES, the routine progresses to step S2 to control the torque Tm of the motor 3 by a feedback method based on the speed Nm of the motor 3. That is, a traction control is carried out at step S2. As the conventional traction control, in order to control a motor torque by the feedback method, a wheel speed Vw and a vehicle speed V are obtained, and an occurrence of wheel slip is determined based on the wheel speed Vw and the vehicle speed V. For this purpose, a target slip ratio St is set to value at which a maximum drive force can be established to propel the vehicle Ve on the current road condition, and the motor torque is controlled in such a manner that the slip ratio S of the wheel is adjusted to the target slip ratio St. However, when travelling on the slippery road where the coefficient of friction μ is low, the motor torque may be diverged with respect to the target value due to control delay or control error.

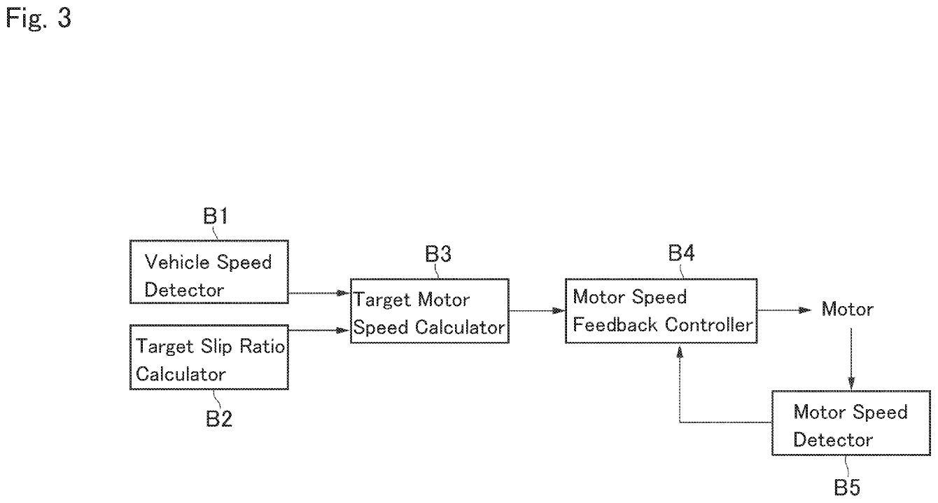

An example of a structure of the controller 5 to execute the feedback control of the torque Tm of the motor 3 is shown in FIG. 3. As illustrated in FIG. 3, the controller 5 comprises a vehicle speed detector B1, a target slip ratio calculator B2, a target motor speed calculator B3, a motor speed feedback controller B4, and a motor speed detector B5.

In order to control the torque Tm of the motor 3 by the feedback method, the vehicle speed V is detected by the vehicle speed detector B1 or obtained based on a signal transmitted from a sensor of an anti-lock brake system (neither of which are shown). At the same time, a target slip ratio St is calculated by the target slip ratio calculator B2. For example, the target slip ratio St is calculated based on specifications of the vehicle Ve and the front wheel 1, and according to the exemplary embodiment of the present disclosure, the target slip ratio St is set to approximately 10%. The target motor speed calculator B3 calculates a target speed of the motor 3 based on the vehicle speed V detected by the vehicle speed detector B1, and the target slip ratio St calculated by the target slip ratio calculator B2. The motor speed feedback controller B4 transmits a torque command to the motor 3 so as to adjust the speed Nm of the motor 3 to the target speed calculated by the target motor speed calculator B3. Consequently, the slip ratio S of at least one of the front wheels 1 is reduced to the target slip ratio St. If the actual speed Nm of the motor 3 detected by the motor speed detector B5 is different from the target speed of the motor 3, the motor speed detector B5 sends a command signal to the motor speed feedback controller B4 so as to further adjust the speed Nm of the motor 3. To this end, the actual speed Nm of the motor 3 is detected by the resolver 6 as a rotational angle sensor of the motor 3. Specifically, the resolver 6 detects a rotational angle of a rotor (not shown) of the motor 3 based on an electric signal resulting from reactance change between the rotor and a stator (not shown) of the motor 3.

Turning back to FIG. 2, at step S3, it is determined whether the coefficient of friction μ of the road surface is equal to or higher than a second threshold value μ2 as a “threshold value” of the exemplary embodiment of the present disclosure. As described, the coefficient of friction μ of the road surface may be estimated based on the torque Tm of the motor 3 and the wheel speed Vw of e.g., each of the front wheels 1. According to the exemplary embodiment of the present disclosure, the threshold value μ2 is set within a range from 0.8 to 1.0. If the coefficient of friction μ of the road surface is less than the second threshold value μ2 so that the answer of step S3 is NO, the routine returns to step S2 to repeat the feedback control of the torque Tm of the motor 3 until the coefficient of friction μ of the road surface exceeds the second threshold value μ2. That is, if the vehicle Ve still travels on a low friction road, the traction control is continued until the vehicle Ve starts travelling on a high friction road.

By contrast, if the coefficient of friction μ of the road surface is equal to or greater than the threshold value μ2 so that the answer of step S3 is YES, the routine progresses to step S4 to calculate a required torque Tm_req of the motor 3 based on the position Acc of the accelerator pedal being operated by a driver.

Then, at step S5, an upper limit torque Tm_max of the motor 3 is calculated based on the required torque Tm_req calculated at step S4 and the coefficient of friction μ of the road surface on which the vehicle Ve travels. According to the prior art, the traction control is terminated when the coefficient of friction μ of the road surface exceeds a predetermined threshold value, and the motor torque is controlled based on a position of the accelerator pedal. However, as described, the motor 3 is controlled electrically to enhance response. Therefore, if the motor 3 is controlled based only on the position Acc of the accelerator pedal when the coefficient of friction μ of the road surface increases equal to or higher than the second threshold value μ2, the drive torque may be changed abruptly. Specifically, if the feedback control of the torque Tm of the motor 3 is terminated immediately when the vehicle Ve is allowed to propel without causing wheel slip, the torque of the motor 3 may be increased more than expected. In this situation, in order to prevent such abrupt change in the torque Tm of the motor 3, the torque Tm of the motor 3 is restricted to the upper limit torque Tm_max.

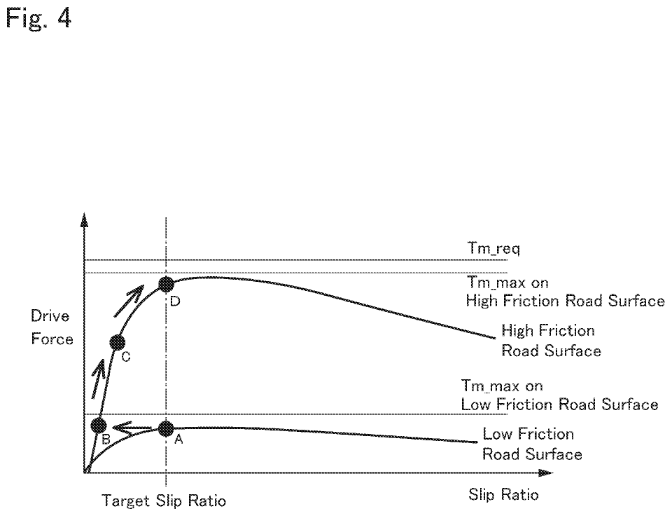

Turning to FIG. 4, there is shown an example of the upper limit torque Tm_max of the motor 3 set at step S5. As indicated in FIG. 4, the upper limit torque Tm_max is set to a value slightly lower than the required torque Tm_req calculated based on the position Acc of the accelerator pedal at step S4, but a difference between the upper limit torque Tm_max and the required torque Tm_req is kept less than a predetermined value. That is, the upper limit torque Tm_max is set in such a manner that the driver will not be frustrated by the shortfall in the torque Tm of the motor 3 with respect to the required torque Tm_req. As described, the upper limit torque Tm_max is calculated based on the coefficient of friction μ of the road surface, and hence the upper limit torque Tm_max is increased with an increase in the coefficient of friction μ of the road surface. Optionally, a lower limit torque Tm_min may also be employed, and for example, the lower limit torque Tm_min may be set to a value at which the front wheel 1 will not be locked. In FIG. 4, the upper limit torque Tm_max of a case in which the coefficient of friction μ of the road surface is equal to or less than the first threshold value μ1 is also indicated. In this case, the upper limit torque Tm_max is set to a value slightly lower than a maximum torque of the motor 3 to propel the vehicle Ve on the slippery road while achieving the target slip ratio St.

Then, at step S6, a smoothing process is applied to the torque Tm of the motor 3. Although the upper limit torque Tm_max is set lower than the required torque Tm_req, if the torque Tm of the motor 3 is increased immediately to the upper limit torque Tm_max when the coefficient of friction μ of the road surface increases equal to or higher than the second threshold value μ2, the torque of the motor 3 may be increased abruptly more than expected. In order to avoid such disadvantage, as indicated in FIG. 4, a torque profile of the motor 3 possible to prevent such abrupt rise in the torque Tm is set at step S6 based on the current coefficient of friction μ of the road surface and the upper limit torque Tm_max calculated at step S5, and the torque Tm of the motor 3 is controlled in line with the torque profile when the coefficient of friction μ of the road surface increases equal to or higher than the second threshold value μ2.

During propulsion on the slippery road where the coefficient of friction μ of the road surface is equal to or lower than the first threshold value μ1, the torque Tm of the motor 3 is controlled in such a manner as to achieve the target slip ratio by the feedback method. Specifically, in the example shown in FIG. 4, the torque Tm of the motor 3 is adjusted to the point A. Then, when the coefficient of friction μ of the road surface increases equal to or higher than the second threshold value μ2, the torque Tm of the motor 3 is adjusted from the point A to the point B on the above-explained torque profile set at step S6. Then, the torque Tm of the motor 3 is increased stepwise from the point B to the point C, and further increased to the point D at which the upper limit torque Tm_max is achieved. Thus, when the vehicle Ve enters the zone in which the coefficient of friction μ of a road surface is high, the torque Tm of the motor 3 will not be increased immediately to the upper limit torque Tm_max which is slightly lower than the required torque Tm_req, and the smoothing process of the torque Tm of the motor 3 is carried out to increase the torque Tm of the motor 3 gradually to the upper limit torque Tm_max. That is, the feedback control of the torque Tm of the motor 3 is continued to increase the torque Tm of the motor 3 smoothly to the upper limit torque Tm_max.

Thereafter, it is determined at step S7 whether a difference between a command torque Tm_cmd of the motor 3 being subjected to the smoothing process and the upper limit torque Tm_max which is slightly lower than the required torque Tm_req is reduced less than a reference value a. In other words, it is determined whether an actual output torque of the motor 3 being increased by the feedback method while being subjected to the smoothing process is increased substantially to the upper limit torque Tm_max. If the difference between the command torque Tm_cmd and the required torque Tm_req is still equal to or greater than the reference value a, the answer of step S7 will be NO. For example, if the torque Tm of the motor 3 has not yet been increased to the upper limit torque Tm_max as indicated by the point C in FIG. 4, the answer of step S7 will be NO, and the routine returns to step S4.

By contrast, if the difference between the command torque Tm_cmd and the required torque Tm_req has been reduced less than the reference value a so that the answer of step S7 is YES, the routine progresses to step S8 terminate the feedback control including the smoothing process of the torque Tm of the motor 3. Consequently, the torque Tm of the motor 3 is controlled based on the position Acc of the accelerator pedal.

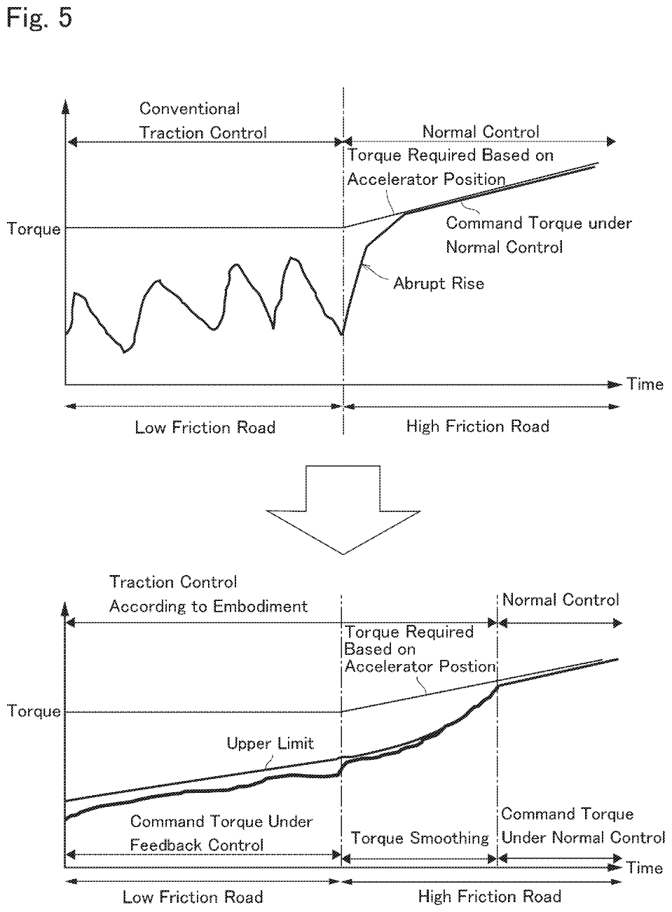

Thus, according to the exemplary embodiment of the present disclosure, the traction control is executed when at least one of the front wheels 1 slips on the low friction road. Specifically, the torque Tm of the motor 3 is controlled by the feedback method based on the target speed possible to achieve the target slip ratio St. An effect of the exemplary embodiment of the present disclosure compared to the conventional traction control is shown in FIG. 5. As can be seen from the upper half of FIG. 5, according to the conventional traction control, the torque of the motor is fluctuated due to hunting during execution of the traction control during propulsion on the low friction road. By contrast, according to the exemplary embodiment of the present disclosure, the torque Tm of the motor 3 is controlled by the feedback method based on the target speed possible to achieve the target slip ratio St during propulsion on the low friction road. According to the exemplary embodiment of the present disclosure, therefore, the torque profile of the motor 3 is smoothed during propulsion on the low friction road as indicated in the lower half of FIG. 5. For this reason, the behavior of the vehicle Ve can be stabilized.

Then, when the vehicle Ve starts propelling on the high friction road where the coefficient of friction μ of the road surface is equal to or higher than the second threshold value μ2, the feedback control of the torque Tm of the motor 3 based on the upper limit torque Tm_max is continued for a predetermined period of time, and in addition, the smoothing process at step S6 is applied to the torque Tm of the motor 3. That is, a timing to start controlling the torque Tm of the motor 3 based on the position of the accelerator pedal is delayed. According to the exemplary embodiment of the present disclosure, therefore, the torque Tm of the motor 3 will not be increased abruptly when the coefficient of friction μ of the road surface increases equal to or higher than the second threshold value μ2. In other words, the torque of the motor 3 will not be increased abruptly more than expected when the vehicle Ve starts travelling on the high friction road, and hence the behavior of the vehicle Ve is stabilized.

Although the above exemplary embodiments of the present disclosure have been described, it will be understood by those skilled in the art that the present disclosure should not be limited to the described exemplary embodiments, and various changes and modifications can be made within the scope of the present disclosure. For example, the feedback control of the torque Tm of the motor 3 may also be commenced upon detection of wheel slip. Here, the slip ratio S of the wheel by dividing: a value obtained by subtracting the vehicle speed V from the wheel speed Vw; by vehicle speed V.

In addition, a target wheel speed may be employed in the feedback control shown in FIG. 3, instead of the target slip ratio St. In this case, speed of the motor 3 is controlled in such a manner as to achieve the target wheel speed. Further, although the coefficient of friction μ of the road surface is compared to the first threshold value μ1 and the second threshold value μ2 in the foregoing embodiment, the determination of the coefficient of friction μ of the road surface may also be made by comparing the coefficient of friction μ of the road surface to only one threshold.

Here, it is to be noted that the feedback control shown in FIG. 3 that is executed at step S2 corresponds to the “first feed back control” of the embodiment, and the feedback control executed at step S6 shown in FIG. 4 corresponds to the “second feedback control” of the embodiment.

What is claimed is:

1. A control system for a vehicle having a motor as a prime mover, that controls a torque of the motor based on a position of an accelerator pedal operated by a driver when a coefficient of friction of a road surface is equal to or higher than a threshold value, comprising:
a controller that controls the vehicle,
wherein the controller is configured to
determine whether the coefficient of friction of the road surface is equal to or lower than another threshold value,
calculate a target speed of the motor that can adjust a slip ratio of a drive wheel to a target slip ratio when the coefficient of friction of the road surface is equal to or lower than the another threshold value, and
execute a first feedback control to control the torque of the motor thereby adjusting a speed of the motor to the target speed.

2. The control system for the vehicle as claimed in claim 1, wherein the first feedback control is executed based on a rotational angle of the motor detected by a resolver.

3. The control system for the vehicle as claimed in claim 1, wherein the controller is further configured to
determine whether the coefficient of friction of the road surface increases equal to or higher than the threshold value,
calculate an upper limit torque of the motor based on the coefficient of friction of the road surface and a required torque calculated based on the position of the accelerator pedal, when the coefficient of friction of the road surface increases equal to or higher than the threshold value, and
execute a second feedback control to control the torque of the motor while employing the upper limit torque as a target torque.

4. The control system for the vehicle as claimed in claim 3, wherein the upper limit torque is set lower than the required torque.

5. The control system for the vehicle as claimed in claim 3, wherein the controller is further configured to apply a smoothing process to the torque of the motor to increase the torque of the motor gradually to the upper limit torque, when the coefficient of friction of the road surface increases equal to or higher than the threshold value.

6. The control system for the vehicle as claimed in claim 3, wherein the controller is further configured to continue the second feedback control for a predetermined period of time after the coefficient of friction of the road surface increases equal to or higher than the threshold value.

7. The control system for the vehicle as claimed in claim 6, wherein the controller is further configured to
terminate the second feedback control after lapse of the predetermined period of time, and
control the torque of the motor based on the position of the accelerator pedal after the termination of the second feedback control.

8. The control system for the vehicle as claimed in claim 1, wherein the target speed of the motor includes at least one of a speed at which the target slip ratio can be achieved, and a speed at which a target wheel speed can be achieved.
